(19) United States
(12) Patent Application Publication
(10) Pub. No.: US 2006/0059149 A1
(43) Pub. Date: Mar. 16, 2006

(54) Generation of anonymized data records from productive application data

(76) Inventors: Peter Dunki, Zurich (CH); Christoph Frei, Baden (CH)

Correspondence Address: MICHAEL BEDNAREK;PILLSBURY WINTHROP SHAW PITTMAN LLP, 1650 TYSONS BOULEVARD, MCLEAN, VA, 22102, US

(21) Appl. No.: 11/200,003

(22) Filed: Aug. 10, 2005

(30) Foreign Application Priority Data
Sep. 15, 2004 (EP) 04 021 926.3

(51) Int. Cl. G06F 17/30

(52) U.S. Cl. 707/6

(57) ABSTRACT

A mechanism is described for the computer-aided generation of anonymized data records for the development and testing of application programs that are intended for use in a productive network (12). A method according to the invention comprises the provision of at least one productive database (14) containing data records to be anonymized that contain static and non-static data elements, the non-static data elements being generated and/or processed by application programs in the productive environment (12) and the static data elements being essentially invariable in the productive environment (12). The method comprises, in addition, reading a plurality of productive data records out of the productive database (14) and generating anonymized data records by replacing at least some of the static data elements of a first productive data record with the corresponding static data elements of a second productive or historicized productive data record. The anonymized data records are then transferred to a development or test environment (27).

### FIELD OF THE INVENTION

The invention relates to the field of data anonymization. Stated more precisely, the invention relates to the generation of anonymized data records for the development and testing of computer applications (hereinafter referred to as applications).

### BACKGROUND OF THE INVENTION

The development and testing of new applications requires the presence of data that can be processed by the new applications in trial runs. In order to be able to attribute a reliable information content to the results of the trial runs, it is essential that the data processed in the trial runs are equivalent in a technical respect (for example, as concerns the data format) to those data that are to be processed by the new applications subsequent to the development and test phase. For this reason, within the framework of the trial runs, those application data are frequently used that were generated by the currently productive (predecessor) versions of the applications to be developed or to be tested. These data, hereinafter referred to as productive application data or simply as productive data, are normally stored in databases in the form of data records.

The use of productive application data for development and test purposes is in practice not without problems. Thus, it has emerged that the data spaces accessible by the developers on the basis of their respective authorization in the productive environment are frequently not large enough to obtain reliable results. The results of trial runs also vary from developer to developer on the basis of their individual-specific data space authorizations. The data space authorization of individual persons can indeed be temporarily expanded for the trial runs; this measure is, however, expensive and, in the case of sensitive or confidential data in particular, is not possible without further checks or restrictions.

Another approach in regard to the use of sensitive or confidential productive application data within the framework of trial runs is to perform the trial runs on a compartmentalized and access-protected central test system. However, the technical cost associated with setting up such a central test system is high. In addition, such a procedure does not permit any delivery of data to (decentralized) development and test systems for error analysis.

The above-explained and further disadvantages have led to the insight that the use of productive data for development and test purposes is ruled out in many cases. An alternative to the use of productive data was therefore sought. On the one hand, said alternative should present a realistic image of the productive data in regard to the data format, the data content, etc. On the other hand, the additional technical precautions, in particular as concerns the protection against unauthorized access (authorization mechanisms, fire walls, etc.) should be capable of being kept to a minimum as far as possible.

It has emerged that the above-cited requirements are fulfilled by test data that are generated by a partial anonymization (or masking) of productive data records. By anonymizing sensitive elements of the productive data, the potential damage that could be anticipated in the event of unauthorized accesses is reduced. This makes it possible to relax the safety mechanisms. In particular, the test data for trial runs and for error analysis can be loaded onto decentralized systems. On the other hand, since, however, the technical aspects (data format, etc.) of the productive application data do not have to be altered or have to be altered only slightly by a suitable anonymization mechanism, the anonymized test data form a realistic image of the productive data.

A data record can be anonymized by erasing the data elements to be anonymized or by overwriting such data elements by a predefined standard text identical for all the data records, while the data elements not to be anonymized are retained unaltered. Such a procedure leads to anonymized data records without (substantial) changes arising in the data format. It has, however, become apparent that trial runs using such anonymized data records do not reveal all the weak points in the application to be developed or to be tested and frequently errors still occur during initial use of the application in the productive environment.

The occurrence of errors in the productive environment, which are to be ascribed, as a rule, to defective programming of the application, is proof that the anonymized data used in the trial runs in the development and testing environment do not (yet) correspond to a sufficient degree to the productive data. Programming errors occur more frequently in the development and testing environment than in the productive environment. This fact therefore requires the existence of effective error analysis mechanisms.

The object underlying the invention is to provide an efficient approach to the provision of anonymized test data. For the abovementioned reasons, the test data are intended to be as faithful a copy as possible of the productive data and, in addition, permit a reliable error analysis. In total, the information content of trial runs is to be improved using the anonymized test data and the failure probability of newly developed or further developed applications in the productive environment is to be reduced.

### SUMMARY OF THE INVENTION

In accordance with a first aspect of the invention, this object is achieved by a test-data anonymization method that generates anonymized data records for the development and testing of application programs that are intended for use in a productive environment. The method comprises the steps of providing at least one productive database containing productive data records that are to be anonymized and that contain static and non-static data elements, the non-static data elements being at least one of generated and handled by application programs in the productive environment and the static data elements being substantially invariable in the productive environment, reading a plurality of productive data records from the productive database, generating anonymized data records by replacing at least some of the static data elements of a first productive data record with the corresponding static data elements of a second productive or historicized productive data record and transferring the anonymized data records to a development and/or test environment.

The data record anonymization therefore takes place by “mixing” the data elements of two or more different productive (or formerly productive) data records. In accordance with this procedure, the statistical properties of the productive data records are at least essentially retained in the anonymized data records. Especially handling steps that are dependent on data content (for example, sorting algorithms) can be tested more reliably if the statistical properties are retained.

The productive data records linked to one another for anonymization purposes may, in accordance with a first variant, all originate directly from the productive database. In accordance with a second variant, only a portion of the productive data records originates directly from the productive database. A further portion originates, for example, from a historicization database that contains copies (already read out at a defined time instant) of productive data records (or at least productive static data elements contained therein), that is to say historicized productive data records. This measure permits the generation of anonymized data records by replacing the static data elements of a first productive data record with the corresponding static data elements of a second historicized productive data record. In this way, productive non-static data elements are combined with historicized static data elements for the purpose of anonymization.

To increase the degree of anonymization, external (for example, publicly accessible) data can be added to the productive data during the anonymization. Thus, static data elements that have been drawn from outside the productive environment can be provided and the anonymized data records can be generated by replacing at least some of the static data elements of the first or a third productive data record with corresponding static data elements from outside the productive environment. To achieve a satisfactory degree of anonymization, it is frequently sufficient to generate less than approximately 25%, preferably less than approximately 10%, of the anonymized data records on the basis of the static data elements drawn from outside the productive environment.

To permit a rapid creation of the anonymized data records (and to burden the productive databases for as short a time as possible with reading accesses), the productive data records can be read out into flat files. The anonymized data records can then be generated by processing the productive data records read out into the flat files. The anonymized data records may also be loaded in the form of flat files into the development and testing environment (for example, into a development and test database). The development and test database preferably have the same structure as the productive database.

Non-static data elements are preferably very short-lived data elements that are normally necessary only for the execution of an individual transaction. Typical OLTP (On-Line Transaction Processing) systems are designed to process many thousands or even millions of individual small transactions per day. In any case, in uncondensed form, the non-static data elements are therefore available only for a short time (although, for reasons of being able to reconstruct individual transactions, they are, as a rule, saved in condensed form). Compared to non-static data elements only current in transactions, the static data elements are markedly longer-lived in terms of time. For this reason, as a rule, many data records contain identical static data elements, but non-static data elements that differ in a transaction-specific way. Despite their long life, the static data elements may also be subject to manipulations, but, compared to the lifetime of typical transaction-specific, non-static data elements, these occur extremely rarely.

The non-static data elements may typically be numerical values that are manipulated by the applications. The static data elements may be identity-related data. These include, for example, name details or address details, identification numbers (such as personal numbers or account numbers), etc.

Although it is conceivable for the entire content of the productive database to be anonymized and transferred to the test and development environment, it is frequently sufficient in practice to anonymize only a portion of the productive data records (for example, up to approximately 30% or 50%) for development and test purposes. Selection criteria can therefore be provided in order to be able to read out selectively data records that fulfil the selection criteria or productive data elements from the productive database.

Preferably, the productive data records are read out of the productive database without interruption (i.e. in one run) in order to obtain an instantaneous picture of the database content and, in particular, of the productive data records. The anonymized data records may be updated, for example, at certain time intervals on the basis of changes in the productive data records (in particular the non-static productive data elements). The use of an historicized database in which at least the static productive data elements are historicized makes it possible always to assign the same static data elements read out of the historicization database to the non-static data elements of a productive database during the generation of the anonymized data records. This measure increases the significance of the information obtained in the development and testing environment.

The static data elements and the non-static data elements of a productive data record may be contained in separate productive databases and may be combined with one another. This measure makes it possible, for example, to provide tailor-made database concepts and security concepts for the data elements having different lifetimes. It is furthermore conceivable that a plurality of productive records exists that have identical static data elements but different non-static data elements. In this case, the use of separate databases promotes the redundancy-free storage of static data elements.

The invention may be implemented as software or as hardware or as a combination of these two aspects. Thus, in accordance with a further aspect according to the invention, a computer program product containing program code means for performing the method according to the invention is provided when the computer program product is executed on one or more computers. The computer program product may be stored on a computer-readable data medium.

In accordance with a hardware aspect of the invention, a computer system is provided for generating anonymized data records for developing and testing application programs that are intended for use in a productive environment. The computer system comprises at least one productive database containing productive data records to be anonymized that contain static and non-static data elements, the non-static data elements being generated and/or processed by application programs in the productive environment and the static data elements being essentially invariable in the productive environment, a computer for reading a plurality of productive data records from the productive database and for generating anonymized data records by replacing at least some of the static data elements of a first productive data record with the corresponding static data elements of a second productive or historicized productive data record and an interface for transferring the anonymized data records to the development or test environment.

### SUMMARY OF THE DRAWINGS

Further advantages and configurations of the invention are explained in greater detail below with reference to preferred embodiments and to the accompanying drawings. In the drawings:

FIG. 1 shows an embodiment of a computer system according to the invention for generating anonymized data records;

FIG. 2 shows a diagrammatic flowchart of a method according to the invention for generating anonymized data records;

FIG. 3 shows a diagrammatic representation of the generation of anonymized data records in accordance with a first embodiment; and

FIG. 4 shows a diagrammatic representation of the generation of anonymized data records in accordance with a second embodiment.

### DESCRIPTION OF PREFERRED EMBODIMENTS

The invention is explained in greater detail below by reference to preferred embodiments. Although one of the embodiments explained is focused on the generation of anonymized data records containing realistic address images, it is pointed out that the invention is not restricted to this field of application. The invention may, for example, be used anywhere where applications are to be tested reliably and with an efficient error analysis mechanism.

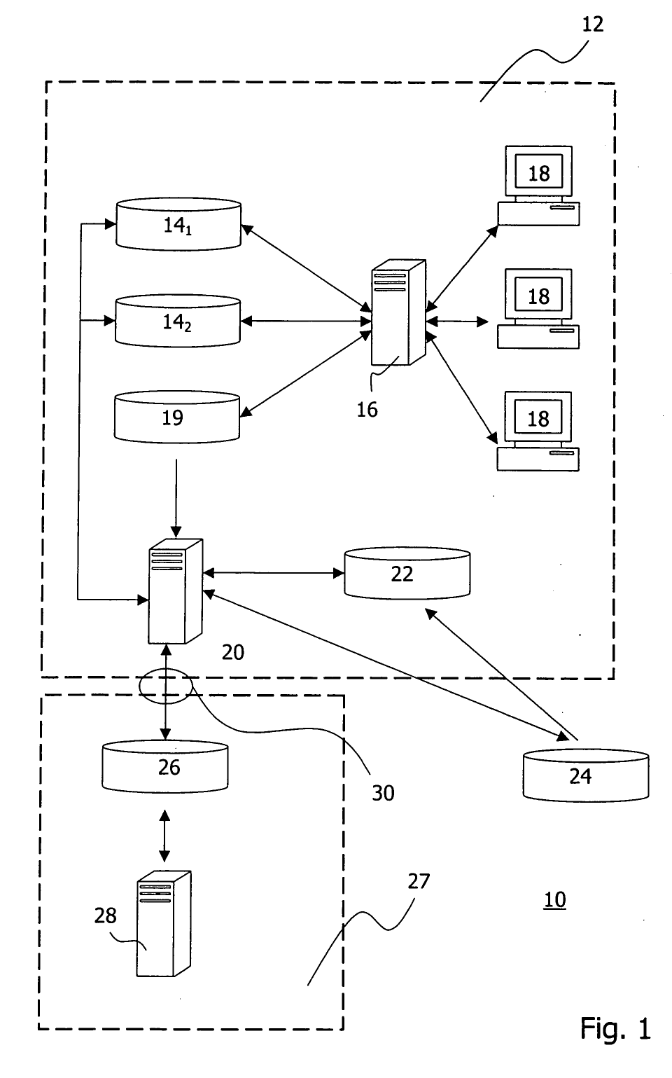

FIG. 1 shows an exemplary embodiment of a computer system 10 according to the invention for generating anonymized data records for developing and testing application programs. In the various embodiments, corresponding elements and components are provided in each case with corresponding reference symbols.

In accordance with the embodiment shown in FIG. 1, the computer system 10 comprises a productive computer network 12 involving a plurality of productive databases 14, at least one application server 16 and also a multiplicity of computer terminals 18. Running on the application server 16 is a plurality of application programs whose services the application server 16 makes available to the computer terminals 18 in the productive network 12. As database server, the application server 16 makes possible, in addition, access to the (productive) data records contained in the productive databases 14. The logically related data elements (or data) of such a data record may be distributed over a plurality of productive databases 14. Thus, static data elements of the productive data records may be stored and maintained in a first productive database 14₁ and non-static data elements of the productive data records may be stored and maintained in a second productive database 142. The productive network 12 and, in particular, the productive databases 14 are protected by a series of security mechanisms against unauthorized accesses. The security mechanisms comprise authentication concepts and user-dependent data space authorizations.

In the productive network 12, use is made of the application programs running on the application server 16 in accordance with the functionalities they are intended to provide. This means that productive application data are constantly transferred between the application server 16 and the productive databases 14, on the one hand, and the application server 16 and the computer terminals 18, on the other. Said productive data have, accordingly, an intended purpose defined by the application programs running on the application server 16. Thus, the application programs may be machine controls, address-based applications (for example, for generating printed matter), components of an ERP (enterprise resource planning) system, a CAD (computer aided design) program, etc. The actual intended purpose of the application data does not affect the scope of this invention.

Furthermore, there is present in the productive network 12 an assignment component 19 that is indicated in the embodiment in accordance with FIG. 1 as a database and whose function is described more precisely below. Depending on the assignment mechanism provided, the assignment component 19 may also be designed as a file, as a cryptographic program routine, etc. Given a suitable authorization, the assignment component 19 can be accessed by some of the computer terminals 18 via the application server 16.

In the exemplary case shown in FIG. 1, the computer system 10 furthermore comprises an anonymization computer 20 disposed inside the productive network 12 and having access to the assignment component 19 and also to three further databases, namely to a non-productive historicization database 22 containing historicized productive data records (still disposed in the productive network 12 for reasons of access control), a publicly accessible electronic database 24 containing public data records and also at least one test database 26 containing anonymized data records. The anonymization computer 20 has reading access to the productive databases 14, the assignment component 19 and the publicly accessible electronic database 24, as well as write/read access to the historicization database 22 and the test database 26.

The functional difference between the productive databases 14 and the non-productive historicization database 22 is essentially that the contents of the productive databases 14 can (continuously) be manipulated by the application server, whereas the non-productive database 22 is a “data preserve” which is not needed by the application programs running on the application server 16 if they are used in accordance with the functionalities they provide.

The publicly accessible electronic database 24 and the test database 26 are located outside the productive network 12 in FIG. 1. More strictly speaking, the test database 26 is disposed inside a development and test environment in the form of a computer network 27. An interface 30 permit a transfer of anonymized data records from the productive network 12 to the test database 26 and, consequently, to the network 27. In its structure, the network 27 resembles the productive network 12 and comprises an application server 28 for development and test purposes. The application server 28 has access to the test database 26. The test database 26 may be structured similarly to the productive databases 14. In order to enable an optimum testing of new or improved applications, the database 26 may have an identical structure to the productive databases 14. This may require splitting up the database 26 into individual, physically separate databases.

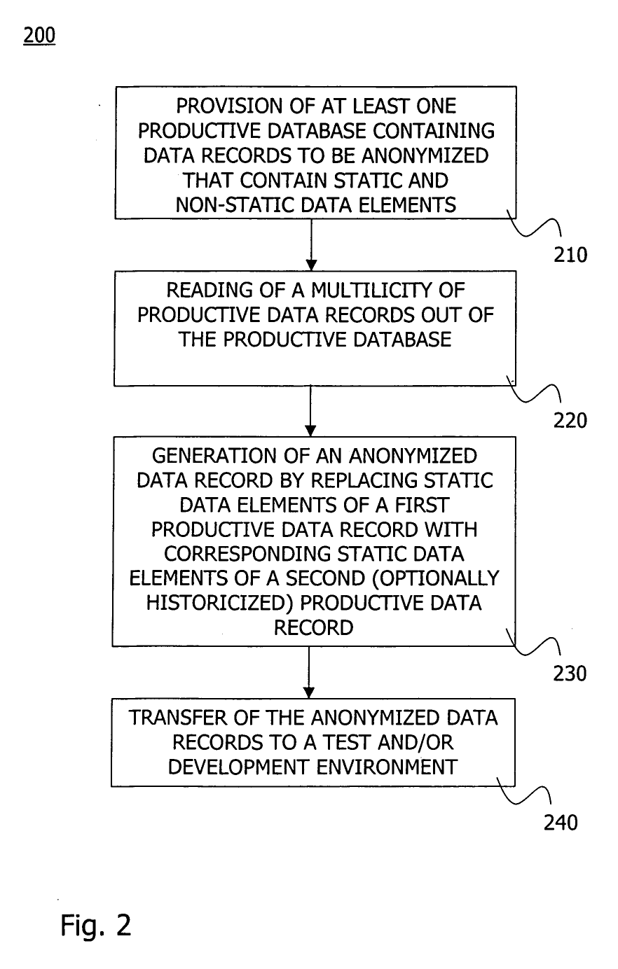

The mode of operation of the computer system 10 shown in FIG. 1 during the generation of anonymized data records in accordance with the anonymization method according to the invention is now explained in greater detail with reference to the flowchart 200 shown in FIG. 2.

The method starts with the provision of the productive databases 14 containing productive data records to be anonymized in step 210. The productive data records comprise individual data elements. More strictly speaking, the data records comprise static and non-static data elements. The static data elements are essentially invariable in the productive network 12, i.e. they are not manipulated (generated, erased, altered, etc.) or only sporadically manipulated by the applications running on the application server 16. The non-static data elements, on the other hand, are very short-lived compared with the static data elements and, in accordance with the particular requirements, are continuously generated, erased, processed, etc. by the application programs in the productive network 12. For this reason, it is primarily the non-static data that are of interest (and therefore should not be anonymized) for development and test purposes. The static data, on the other hand, often require, because of their permanence, anonymization, in particular if they have identity-related contents.

In step 220, a plurality of productive data records is read from the productive databases 14. Reading-out may be based on a selection mechanism based, for example, on user-defined selection criteria. Said selection mechanism takes into account the fact that it is frequently unnecessary for development and test purposes to anonymize all the productive data records and transfer them to the development and test environment. Frequently approximately 15 to 50%, preferably approximately 30%, of the productive data records are sufficient to be able to draw reliable conclusions in the development and test environment.

Reading-out in step 220 may take place in such a way that the data read out are an instantaneous picture of the productive databases 14. In other words, reading out preferably takes place in a time interval kept as short as possible in which at least writing accesses to the databases 14 are (to the greatest possible extent) suppressed. For efficiency reasons, the productive data records are read out into one or more flat (simply structured) files and processed further therein, that is to say, in particular, anonymized.

The data records read out are anonymized in step 230. For this purpose, at least some of the static data elements of a first productive data record are replaced by the corresponding static data elements of a second productive or historicized data record. This replacement may take place in the abovementioned flat files. Expediently, the static data elements of the second productive data record originate from the historicization database 22. Some of the anonymized data records may also be generated by replacing static data elements of the productive data record to be anonymized by static data elements that originate from the publicly accessible electronic database 24. If necessary, some of the non-static data elements (in particular, running text) may also be anonymized. The non-static data elements can be replaced, for example, by dummy data.

In step 240, the data records anonymized in step 230 are transferred to the development and test environment 27, more strictly speaking to the test database 26. This transfer may take place in the form of the above-explained flat file whose contents are written into the test database 26 or in any other form. Furthermore, an updating mechanism may be provided which makes it possible to add changes to the productive data records in the anonymized data records. The updating mechanism may be invoked at regular intervals or by user initiation.

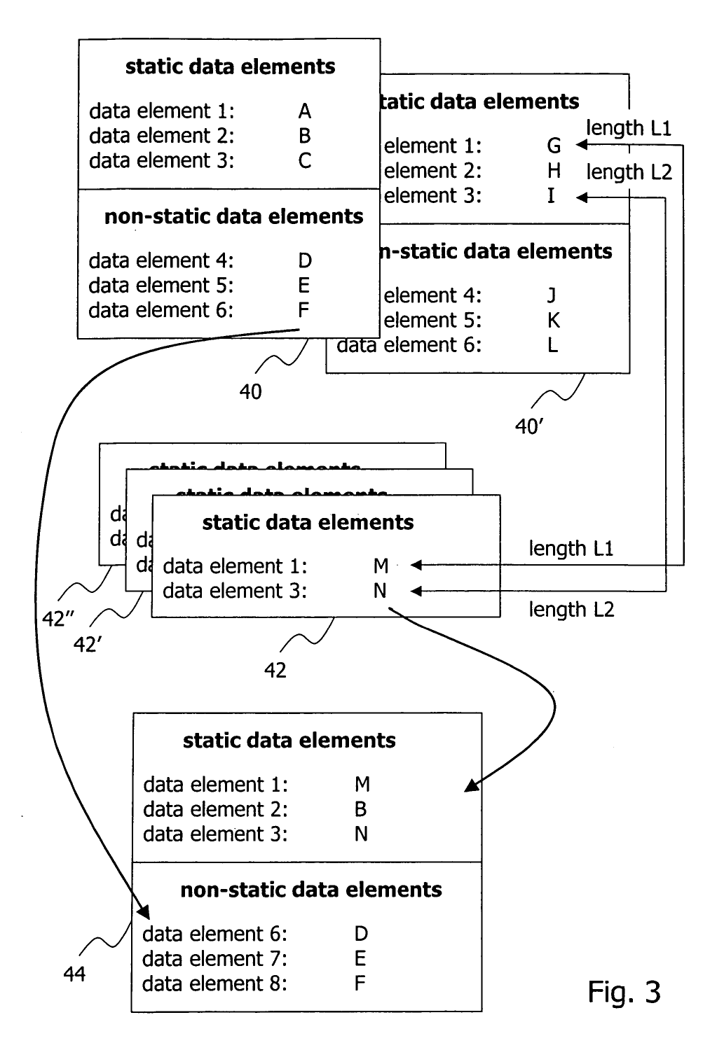

FIG. 3 shows a diagrammatic representation of an exemplary embodiment for the generation of anonymized data records using productive data records 40, 40′ contained in the productive databases 14, on the one hand, and non-productive data records 42, 42′, 42″ contained in the historicization database 22.

The data records contained in the historicized database 22 can be generated in various ways. In accordance with a first variant, said data records were generated by copying productive data records (or at least by copying data elements contained therein). In accordance with a second variant, the historicization database 22 comprises data records that, in regard to the data elements contained therein, originate from the productive databases 14 and the publicly accessible electronic database 24. In this way, an uncertainty factor is generated in such a way that, in the development and test environment on the basis of anonymized data records, the existence of an associated productive data record (and corresponding productive data elements) can no longer be unambiguously inferred from an anonymized data record.

FIG. 3 shows by way of example two productive data records 40, 40′ at the top. Each of said data records 40, 40′ comprises a plurality of productive data elements (A, B, C, . . . ) that can be manipulated (generated, altered, erased, etc.) and processed by the application programs running on the application server 16.

The data elements are subdivided in the exemplary case shown in FIG. 3 into static data elements (or master data) and non-static data elements (or transaction data). A static data element may, for example, be an event datum (for example, a day or year specification), a name, an identification code, an address specification, a setpoint value, etc. On the other hand, the non-static data elements are continuously manipulated by the application programs running on the application server 16 and therefore form, for example, the input or output parameters of said application programs. In the exemplary embodiment in accordance with FIG. 3, it is assumed that only some of the static data elements of the productive data records are to be anonymized, whereas the non-static data elements do not require anonymization and should therefore be available in unaltered form in the development and test environment.

An identifier in the form of a number between 1 and 6 is assigned to each of the individual data elements. Corresponding identifiers are used both for the productive data records 40, 40′ and also for the historicized data records 42, 42′, 42″. This procedure makes it possible to anonymize productive data elements by replacing historicized data elements with a corresponding identifier.

The historicized data records 42, 42′, 42″ comprise, in the example in accordance with FIG. 3, only those data elements that are needed to anonymize the productive data records. Since, in the exemplary embodiment in accordance with FIG. 3, only the productive data elements having the identifiers 1 and 3 have to be anonymized, the historicized data records 42, 42′, 42″ each contain only data elements having the identifiers 1 and 3 to reduce the memory space requirement. In accordance with a modification of the exemplary embodiment in accordance with FIG. 3, it would, however, be possible for the historicized data records 42, 42′, 42″ to have the same format as the above-explained productive data records 40, 40′ (i.e. to comprise static and non-static data elements like the productive data records 40, 40′). In that, case, only the data elements needed for anonymization purposes (here having the identifiers 1 and 3) would be read out of the historicized data records and transferred to the respective anonymized data records to be generated.

As emerges from FIG. 3, the historicized data record 42 corresponds, in regard to the character string lengths of the data elements 1 and 3 contained therein, to the productive data record 40′. In other words, both the data element G having the identifier 1 of the productive data record 40′ and the data element M having the identifier 1 of the historicized data record 42 both have the same character string length L1. Furthermore, both the data element I (identifier 3) of the productive data record 50′ and the data element N (identifier 3) of the historicized data set 42 each have the corresponding length L2. In the historicization database 22, the data record 42 is, however, not unique in regard to the presence of a data element of the identifier 1 having a length L1 and of the data element 3 having a length L2. On the contrary, in the historicization database 22 at least one further data record (for example data record 42′ and/or data record 42″) is present that likewise comprises a data element of the identifier 1 having a length L1 and a data element of the identifier 3 having the length L2.

The generation of an anonymized data record 44 shown in FIG. 3 on the basis of the productive data records 40, 40′ and of the historicized data records 42, 42′ and 42″ now proceeds as follows. In a first step, there is derived from the productive databases 14 (for example, on the basis of a user-definable selection mechanism) at least one productive data record that is to be anonymized and transferred to the test database 26 as an anonymized data record. This is shown in FIG. 3 by way of example for the productive data record 40. Here, it is again assumed that the data elements having the identifiers 1 and 3 of the productive data records are to be anonymized. With respect to the data record 40 in accordance with FIG. 3, the data elements to be anonymized are therefore the data elements A and C. These two data elements A and C are to be replaced by data elements having corresponding identifiers of one of the historicized data records 42, 42′ and 42″.

For the productive data record 40 extracted from the productive databases 14, a data record from the historicization database 22 assigned to said data record 40 is now to be determined (or derived) in a subsequent step (its data elements having the identifiers 1 and 3 are to replace the data elements having the corresponding identifiers of the data record 40). In the exemplary embodiment shown in FIG. 3, the historicized data record 42 is assigned to the productive data record 40. This assignment takes place using the assignment component 19 shown in FIG. 1. The assignment component 19 in FIG. 1 may be based on a cryptographic mechanism, such as, for example, the IDEA encoding mechanism described in U.S. Pat. No. 5,214,703 or EP 0 482 154. Such a mechanism permits to implement an assignment component 19 that reproducibly retains an assignment once defined between the productive data records 40, 40′, etc. and the historicized data records 42, 42′, 42″, etc.

The reproducibility of the assignment allows for an updating of individual anonymized data records in the test database 26. In this way, data modifications can be incorporated in the test database 26 in the productive environment. In particular, in accordance with this updating approach, the content of the test database 26 does not have to be completely regenerated every time. This relieves the load on the existing resources and increases the availability of the productive databases 14.

As shown in FIG. 3, to generate the anonymized data record 44, the data elements having the identifiers 1 and 3 of the productive data record 40 are replaced by the corresponding data elements of the historicized data record 42. More strictly speaking, the data element A is replaced by the data element M and the data element C by the data element N in order to anonymize the productive data record 40. The data elements B, D, E and F of the productive data record 40 do not, on the other hand, require any anonymization and are transferred unaltered to the anonymized data record 44. In FIG. 3, the fact that the anonymized data record 44 has the same format as the productive data record 40 can be clearly perceived.

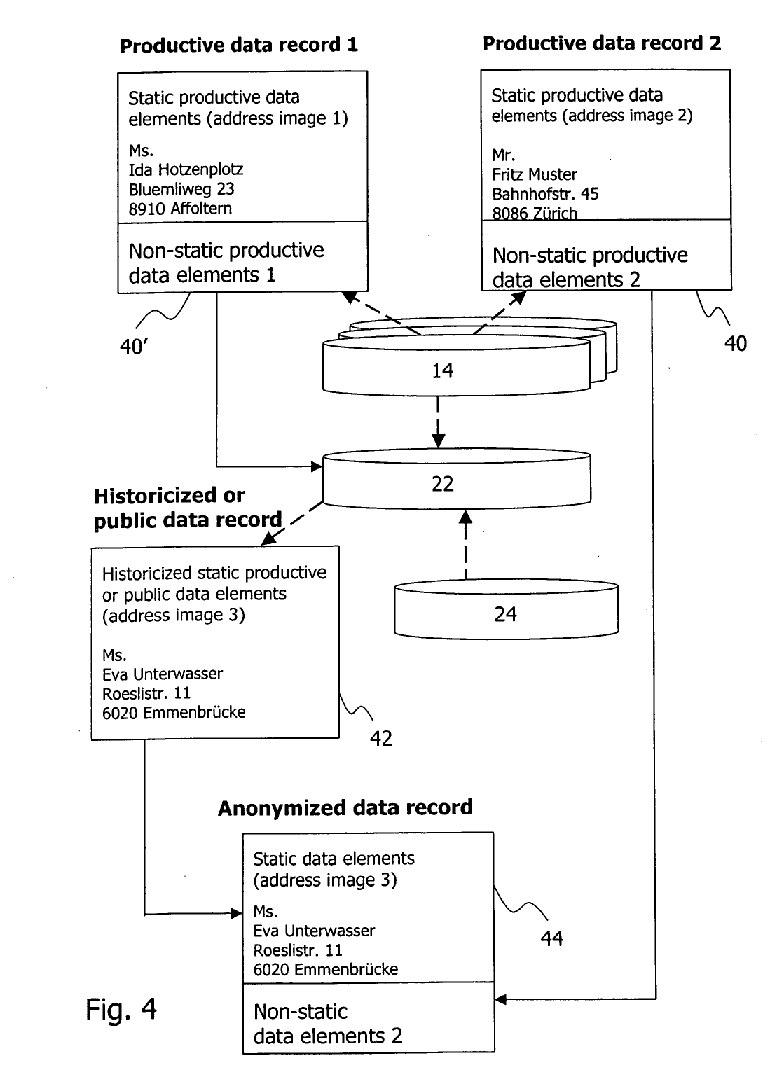

FIG. 4 shows in a diagrammatic representation a further exemplary embodiment for the generation of an anonymized data record by combining data elements of a productive data record with data elements of a further (optionally historicized) productive data record.

The exemplary embodiment shown in FIG. 4 relates to the generation of anonymized data records for developing and testing of especially those application programs that output the data elements contained in the anonymized data records on a display device or in the form of printed matter. More strictly speaking, anonymized data records are to be made available that permit the development and testing of address-based application programs. Such application programs serve, for instance, to create an addressed statement of account containing short-life and transaction based non-static productive data (such as account balances, account turnovers, etc.) and long-life static productive data (such as account numbers, name details and address details). In this connection, for example, it is necessary to ensure that all the relevant address details are shown inside a limited window of an envelope. For this reason, there is the requirement that the anonymized address images are, in regard to their geometrical dimensions, a faithful copy of the productive address images. Owing to the confidentiality of the non-static productive data (bank secret), however, the complete productive data records must not be used in creating test statements of account for development and test purposes. On the contrary, the object is to assign anonymized address images to the non-static productive data.

For this purpose, as shown in FIG. 4, a historicization database 22 containing historicized data records is again created in a first step. This takes place in such a way that a user-selected selection of the address images (that is to say of the static data elements) contained in the productive databases 14 are transferred to the historicized database 22. To improve the degree of anonymization, address images are furthermore loaded from the publicly accessible electronic database 24 (for example, from an electronic telephone book) into the historicization database 22. Approximately 10% of the data records of the historicization database 22 originate from the publicly accessible electronic database 24.

In accordance with a variant of the exemplary embodiment shown in FIG. 4, only the data elements name and first name are transferred from the productive databases 14 to the historicization database 22. In the latter, these two data elements are combined with address details (for example, street, town, etc.) that may originate from the publicly accessible electronic database 24. In addition, complete address images (including first name and surname) may also be extracted from the publicly accessible electronic database 24 to generate historicized productive data records. This measure is expedient, in particular, if yet further data elements are needed (in addition to the data elements read out of the productive databases 14) to ensure that no data record having an unambiguous character string length combination occurs in the historicization database 22.

In accordance with the exemplary embodiment shown in FIG. 4, the historicized data records do not correspond, in regard to their character string length statistics of the data elements first name and surname (appropriate data element identifiers are used internally but are not shown in FIG. 4), to productive data records. This implies, for example, that, for the productive address image 1 of the productive data record 40′ comprising a three-character first name (Ida) and a surname comprising eleven characters (Hotzenplotz), there is a corresponding historicized data record 42 containing a historicized address image that likewise provides a first name (Eva) comprising three characters (Eva) and a surname comprising eleven characters (Unterwasser). For the anonymized data record 44 to be generated and for development and test purposes, it is irrelevant in this connection whether the data elements of the address image of the historicized data record 42 originate from the publicly accessible electronic database 26 or, alternatively, from the productive database 14.

Furthermore, the statistical properties of the data records, data elements and of data element segments in the historicization database 22 are approximated to the greatest possible extent to the statistical properties of the data records, data elements and of data element segments in the productive databases 14. This relates, for example, to the statistical distributions of the character string lengths and also to the statistical distributions of the initial letters at least of the surnames. This measure facilitates the development and testing of application programs that comprise, for example, sorting algorithms or similar selective mechanisms.

To generate the anonymized data record 44 shown in FIG. 4, one data record 40 is first determined (or derived) from the productive databases 14 and also precisely one assigned data record is determined (or derived) from the historicized database 22. In the exemplary embodiment in accordance with FIG. 4, the historicized data record 42 is assigned to the productive data record 40. The historicized data record 42 comprises (at least) one historicized address image that replaces, for the purpose of anonymizing the productive data record 40, its productive address image. The anonymized data record 44 to be generated then comprises, in addition to the address image of the data record 42 read out of the historicized database 22, the non-static data elements of the productive data record 40. If necessary, individual non-static productive data elements of the productive data record 40 can likewise also be anonymized. The (historicized) data necessary for this purpose can be extracted from the historicized data record 42 or generated in another way.

As became evident from the above description, the invention permits, in a simple way, the generation of anonymized data records from productive data records. The mechanism is robust and ensures an adequate degree of anonymization. In particular, the mechanism makes it possible to retain the statistical properties of the productive data in the development and test environment. This increases the reliability of the applications to be developed and to be tested.

Although the invention was described on the basis of a plurality of individual embodiments that can be combined with one another, numerous changes and modifications are conceivable. The invention can therefore be practised even deviating from the above exposition within the scope of the claims below.

1. A method for the computer-aided generation of anonymized data records for developing and testing application programs that are intended for use in a productive environment, comprising the steps of:
providing at least one productive database containing productive data records to be anonymized that contain static and non-static data elements, the non-static data elements being at least one of generated and processed by application programs in the productive environment and the static data elements being substantially invariable in the productive environment;
reading a plurality of productive data records out of the productive database;
generating anonymized data records by replacing at least some of the static data elements of a first productive data record with the corresponding static data elements of a second productive or of a historicized productive data record;
transferring the anonymized data records to a development or test environment.

2. The method according to claim 1, further comprising the steps of:
providing static data elements that are drawn from outside the productive environment; and
generating anonymized data records by replacing at least some of the static data elements of the first or of a third productive data record with corresponding static data elements from outside the productive environment.

3. The method according to claim 2, wherein less than approximately 25% of the anonymized data records are generated on the basis of the static data elements drawn from outside the productive environment.

4. The method according to claim 1, further comprising the step of historicization of at least the static data elements of the productive data records for the purpose of generating historicized productive data records.

5. The method according to claim 1, further comprising the steps of:
reading out the productive data records into flat files; and
processing the productive data records read out into the flat files to generate the anonymized data records.

6. The method according to claim 1, wherein the anonymized data records are loaded into the development or test environment in the form of flat files.

7. The method according to claim 1, further comprising the step of loading the anonymized data records into a development and test database that has the same structure as the productive database.

8. The method according to claim 1, wherein the non-static data elements are numerical values.

9. The method according to claim 1, wherein the static data elements are identity-related data.

10. The method according to claim 1, further comprising the steps of:
providing selection criteria; and
selective reading of the productive data records or productive data elements that fulfil the selection criteria out of the productive database.

11. The method according to claim 1, wherein the productive data records are read out of the productive database without interruption in such a way that an instantaneous picture of the database content or a portion thereof is obtained.

12. The method according to claim 1, further comprising the step of updating the anonymized data records on the basis of changes in the productive data records.

13. The method according to claim 1, wherein the static data elements and the non-static data elements of the productive data records are contained in separate productive databases, but are linked to one another.

14. The method according to claim 1, wherein a plurality of productive data records exists that have identical static data elements, but different non-static data elements.

15. A computer program product comprising program code means for performing the method according to claim 1 when the computer program product is executed on one or more computers.

16. The computer program according to claim 15, stored on a computer-readable data medium.

17. A computer system for generating anonymized data records for developing and testing application programs that are intended for use in a productive environment, comprising:
at least one productive database containing productive data records to be anonymized that contain static and non-static data elements, the non-static data elements being at least one of generated and processed by application programs in the productive environment and the static data elements being substantially invariable in the productive environment;
a computer for reading a plurality of productive data records out of the productive database and for generating anonymized data records by replacing at least some of the static data elements of a first productive data record with the corresponding static data elements of a second productive or historicized productive data record;
an interface for transferring the anonymized data records to a development or test environment.

18. The computer system according to claim 17, further comprising a historicization database containing historicized productive data records.
